(19) United States
(12) Patent Application Publication
(10) Pub. No.: US 2007/0256054 A1
(43) Pub. Date: Nov. 1, 2007

(54) Using 3-dimensional rendering effects to facilitate visualization of complex source code structures

(76) Inventors: Paul Byrne, Los Altos, CA (US); Hideya Kawahara, Mountain View, CA (US); Charles J. Hunt, Libertyville, IL (US)

Correspondence Address: SUN MICROSYSTEMS INC.;C/O PARK, VAUGHAN & FLEMING LLP, 2820 FIFTH STREET, DAVIS, CA, 95618-7759, US

(21) Appl. No.: 11/413,803

(22) Filed: Apr. 28, 2006

(51) Int. Cl. G06F 9/44

(52) U.S. Cl. 717/113

(57) ABSTRACT

One embodiment of the present invention provides a system that uses three-dimensional (3D) rendering effects within a 3D graphical user interface (GUI) to enable a user to efficiently visualize and navigate through complex source code structures. During operation, the system receives a request to display a set of source code files in a 3D GUI. Next, in response to the request, the system displays each source code file as a scaled-down version of the actual source code within a box in the 3D GUI, wherein the box is scaled to fit within a viewing window of the 3D GUI regardless of the length of the source code in the file. Note that the scaled-down source code within the box preserves the structure of the actual source code file, including line lengths and indentations. The system also displays calls between source code files as links between source code lines associated with the calls, wherein the links form a call-graph between the set of source code files.

### BACKGROUND

1. Field of the Invention

The present invention relates to user-interfaces for computer systems. More specifically, the present invention relates to a method and an apparatus that uses advanced graphics rendering techniques to enable a user to efficiently visualize and navigate through complex source code structures.

2. Related Art

Modern integrated development environments (IDEs) provide a user with a wide range of tools to explore a project's source code. In particular, some tools allow the user to perform queries to determine where a particular variable is used, and where a particular method is called from. Unfortunately, these existing tools have significant limitations in the way the query results are presented to the user.

For example, consider a query for a method which is called from 10 locations spread across 8 source code files. In this case, an existing system typically displays two pieces of information which are useful to the user: (1) the list of source code files which contain the calls to the method in question; and (2) the actual calls themselves from the list of source code files. Traditionally, this information is presented to the user in a form which is constrained by the two-dimensional (2D) rendering capability of the user interface (UI) associated with the IDE. Specifically, the UI first displays the list of source code files with one-line tags representing the source code files. Next, the user selects a tag associated with a source code file and the UI in turn displays the source code in a separate editor window. However, because of the 2D visual limitations of the UI, the display environment quickly becomes crowded when more than just a few editor windows are displayed within the IDE.

Another limitation of existing IDEs arises when displaying a call-graph associated with a list of source code files for a project, wherein the call-graph displays call relationships between methods in the source code files. Traditionally, a display of such a call-graph is presented to the user as a 2D graph, wherein the functions/methods are represented as nodes and the call relations to these functions/methods are represented as arcs. Unfortunately, when a standard 2D UI is used to display complex source code structures, the associated call-graph can easily clutter the display, making the links very hard to follow or even unreadable.

The problem becomes even more challenging when the user desires to view the call-graph together with the associated source code in the same display environment. Conventional 2D display techniques, such as tiling or cascading the editor windows in the display can make the visual representation more readable. However, the source code files are often long. Consequently, calls can potentially link to the source code lines that are far apart. Because only a small section of such source code is visible at one time, it can be very hard if not impossible to display the whole call-graph along with the associated source code. Hence, even in the above-described simple example, it can be difficult for the user to get a comprehensive picture of the program control flow.

Hence, what is needed is a method and an apparatus that allows a user to efficiently visualize and navigate through complex source code structures without the above-described problems.

### SUMMARY

One embodiment of the present invention provides a system that uses three-dimensional (3D) rendering effects within a 3D graphical user interface (GUI) to enable a user to efficiently visualize and navigate through complex source code structures. During operation, the system receives a request to display a set of source code files in a 3D GUI. Next, in response to the request, the system displays each source code file as a scaled-down version of the actual source code within a box in the 3D GUI, wherein the box is scaled to fit within a viewing window of the 3D GUI regardless of the length of the source code in the file. Note that the scaled-down source code within the box preserves the structure of the actual source code file, including line lengths and indentations. The system also displays calls between source code files as links between source code lines associated with the calls, wherein the links form a call-graph between the set of source code files.

In a variation on this embodiment, the system allows a user to zoom in and zoom out on each scaled-down version of a source code file by using 3D rendering effects to increase and decrease the visual resolution of the contents within the associated box.

In a further variation on this embodiment, a box containing a source code file transforms into a code editor window for the associated source code file at a specific zoom-in level, which allows a user to edit the source code file.

In a variation on this embodiment, the boxes associated with the scaled-down versions of the source code files can overlap in the 3D GUI to facilitate a compact visual representation, wherein portions of the boxes which overlap are displayed through translucency.

In a variation on this embodiment, the system allows a user to rotate and move around the boxes associated with the scaled-down version of the source code files using the 3D rendering effects to enable the user to view the contents within the boxes from different angles.

In a variation on this embodiment, if the user edits a source code file, the associated call-graph between the set of source code files is updated concurrently.

In a variation on this embodiment, the 3D GUI is part of an integrated development environment (IDE).

In a variation on this embodiment, the system facilitates displaying debugging tools within the 3D GUI, which involves displaying: (1) call stacks associated with the source code files; and (2) stack variables associated with the call stacks.

### BRIEF DESCRIPTION OF THE FIGURES

FIG. 1 illustrates a computer system architecture that supports a three-dimensional (3D) graphical user interface (GUI) for displaying user applications in accordance with an embodiment of the present invention.

FIG. 2 illustrates an exemplary screen shot of a conventional IDE.

FIG. 3 illustrates a screen shot of an exemplary IDE 200 which includes a 3D source code editor window in accordance with an embodiment of the present invention.

FIG. 4 illustrates an exemplary result after applying a zoom-in effect to the selected box in FIG. 3 in accordance with an embodiment of the present invention.

FIGS. 5A and 5B illustrate rotated views of the scaled-down 3D version of the source code files in FIG. 3 at different viewing angles in accordance with an embodiment of the present invention.

FIG. 6 presents a flowchart illustrating the process of applying 3D rendering effects to a source code editor in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

A System Software Architecture

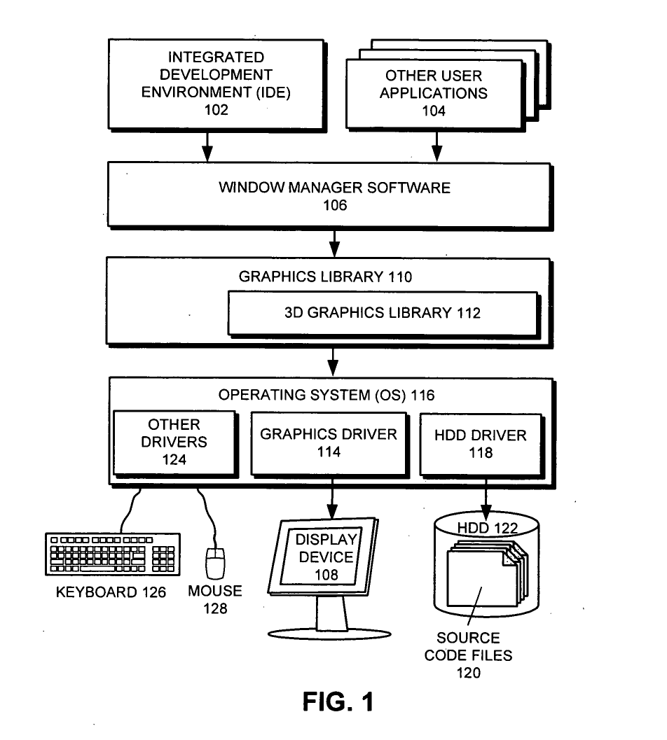

FIG. 1 illustrates a computer system architecture that supports a three-dimensional (3D) graphical user interface (GUI) for displaying user applications in accordance with an embodiment of the present invention.

The user applications can include an integrated development environment (IDE) 102 for source code development, and other user applications 104. Window manager software 106 manages displaying IDE 102 and other user applications 104 through a display device 108 of the computer system, which involves managing the appearance and position of user interfaces for the user applications on display device 108.

Window manager software 106 utilizes a graphics library 110 to generate and manipulate graphics for such user interfaces. In particular, graphics library 110 comprises a 3D graphic library 112, which contains functions for rendering 3D visual effects for user applications and presenting the 3D visual effects to graphics driver 114, which is part of operating system 116. Graphics driver 114 communicates with display device 108, which in turn displays the graphical output for the user applications on display device 108. The 3D graphics library can include, but is not limited to, OpenGL, OpenGL ES, and DirectX.

Additionally, window manager software 106 can interact with other device drivers within operating system 116 on behalf of the user applications. In particular, hard-disk drive (HDD) driver 118 facilitates saving and retrieving source code files 120 associated with IDE 102 to and from HDD 122. The other drivers 124 can include a keyboard driver and a mouse driver which receive user inputs from keyboard 126 and from mouse 128, respectively.

A Conventional IDE

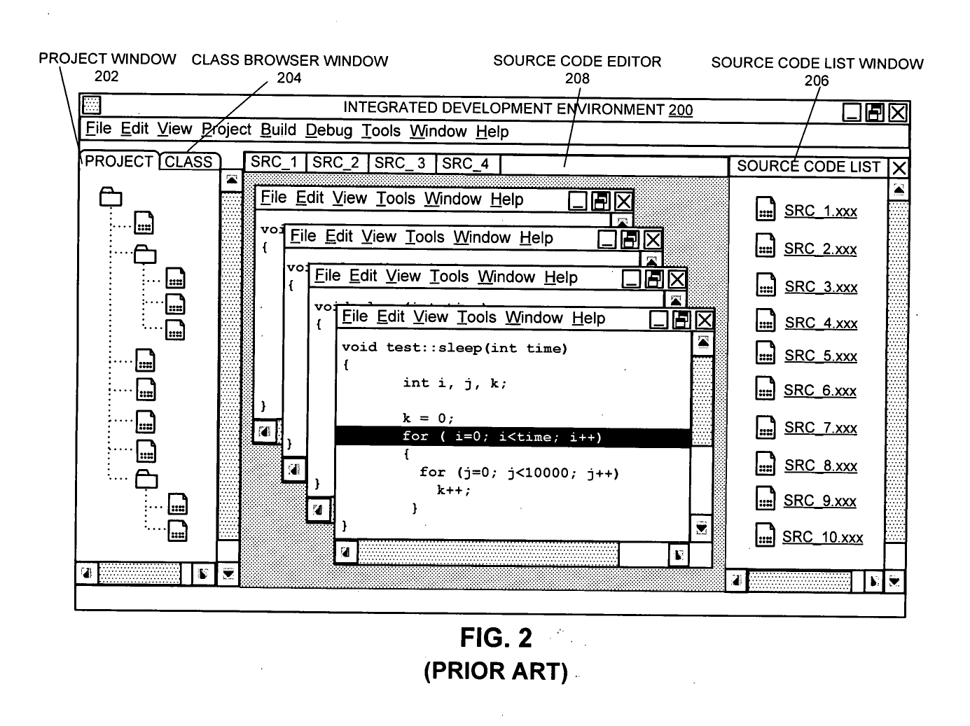

FIG. 2 illustrates an exemplary screen shot of a conventional IDE 200. IDE 200 includes a project window 202, which displays a tree illustrating the file structure of a project. Project window 202 can be toggled to bring up a class browser window 204, which presents class information associated with the project. IDE 200 further includes a source code list window 206, which presents a list of source code files as associated clickable file names. These source code files are related if they contain calls to a specific method, which can be queried by a user.

In the main area of IDE 200 is a source code editor 208. Note that source code editor 208 provides a 2-dimensional display environment. When a user selects a file to display from source code list window 206, a new editor window is created in source code editor 208 which allows the source code file to be edited. In the example in FIG. 2, four source code files SRC_1, SRC_2, SRC_3, and SRC_4 have been selected from the list and the four associated editor windows are displayed in cascade.

Although not shown in FIG. 2, IDE 200 can also include: a complier window; an interpreter window; a build-automation window; and a debugger window. Furthermore, although we show an IDE 200 for an object-orientated programming language, an IDE can generally be used for developing any programming language, such as the C programming language, Visual BASIC, or XML.

An IDE with a 3-Dimensional (3D) Source Code Editor

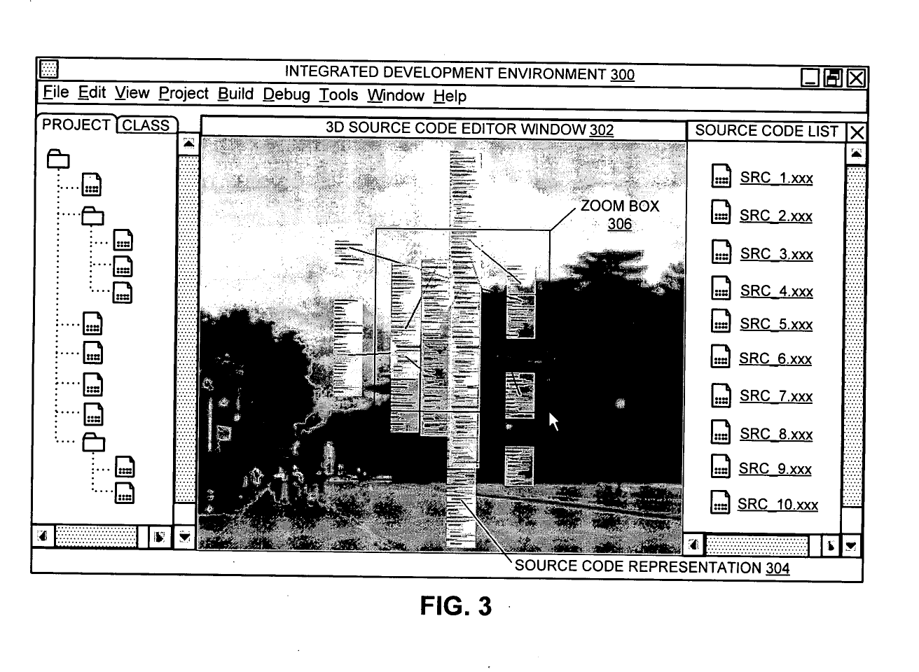

One embodiment of the present invention uses 3D rendering techniques to enable a user to efficiently visualize and navigate through complex source code structures, such as a call-graph. For example, FIG. 3 illustrates a screen shot of an exemplary IDE 300 which includes a 3D source code editor window 302 in accordance with an embodiment of the present invention. A significant difference between IDE 200 and IDE 300 is that source code editor window 302 provides a 3D graphical user interface (GUI).

Within 3D source code editor window 302, the system displays each source code file as a scaled-down version of the actual source code within a rectangular box. Each box is scaled in proportion to the length of the source code file and fits within the 3D source code editor window 302, regardless of the length of the source code in the box. Instead of using scrollable windows, and only displaying a segment of the source code, the scaled-down version allows the entire source code to be within the viewing area. This is particularly beneficial for very long source code files. For example, source code representation 304 may contain hundreds of lines of code which would require a scrollable window if it is displayed in the conventional manner. While in FIG. 3, it fits perfectly within the window 302, allowing a user to view all of the source code.

Note that the high-level visualization of the source code file in the 3D GUI provides a great deal of information to a user. For example, even though the text of the source code is scaled down to well below a readable size, the high-level visualization preserves the structure of the code (i.e., the line length and indentation) and the appropriate text colors. This provides visual cues to a code developer who is familiar with the source code file. This enables the code developer to recognize specific methods or functions and possibly individual lines within the source code.

Moreover, in FIG. 3 straight lines are used to represent call paths from one line of source code to another, wherein a collection of these lines form a call-graph for the set of source files. Because each scaled-down version presents a high-level view of the entire source code file, each link in the call-graph can be positioned to connect the actual locations of the two lines of source code associated with the call. Note that although we have shown links as straight lines, other line styles can be used, and different lines colors can be used to represent different types of control flows, such as loops and recursion between the source code files.

Another feature of using this high-level representation of the source files is that the entire set of the source code files can be displayed simultaneously within a 3D source code editor window 302, without causing a feeling of crowding.

In one embodiment of the present invention, the initial layout of the display including the call-graph is computed from the query that the user entered. If the user selects a new query later on, the files and the graph are dynamically updated to reflect the new call hierarchy. Hence, the user can quickly explore many method calls within an application and obtain an overall feel for the control flow within the application. In one embodiment of the present invention, when the user edits a source code file within 3D source code editor window 302, the associated call-graph between the set of source code files is updated automatically.

Furthermore, the boxes associated with the scaled-down versions of the source code files can overlap in the 3D GUI to facilitate a more compact visual representation. In one embodiment of the present invention, portions of the source code which are blocked by one or more overlapping boxes above them are made visible through translucency effects. Such translucency effects also allow the links which are blocked due to overlapping of the boxes to remain visible, so that the user always can have a complete view of the entire call-graph.

When the user needs to see more details about a scaled-down box, the 3D rendering capability of the display environment 302 allows the user to smoothly zoom into each scaled-down version of a source code file. In doing so, the user can increase visual resolution of the contents within the associated box to any desired level. Because the entire source code file is presented to the user, the user can conveniently locate a specific line within the file as the center of the zoom regardless of the actually length of the file.

In one embodiment of the present invention, the user can zoom into a specific area of the 3D source code editor window 302 by first dragging a zoom box 306 around the area of interest, and subsequently zooming into the box using 3D rendering effects.

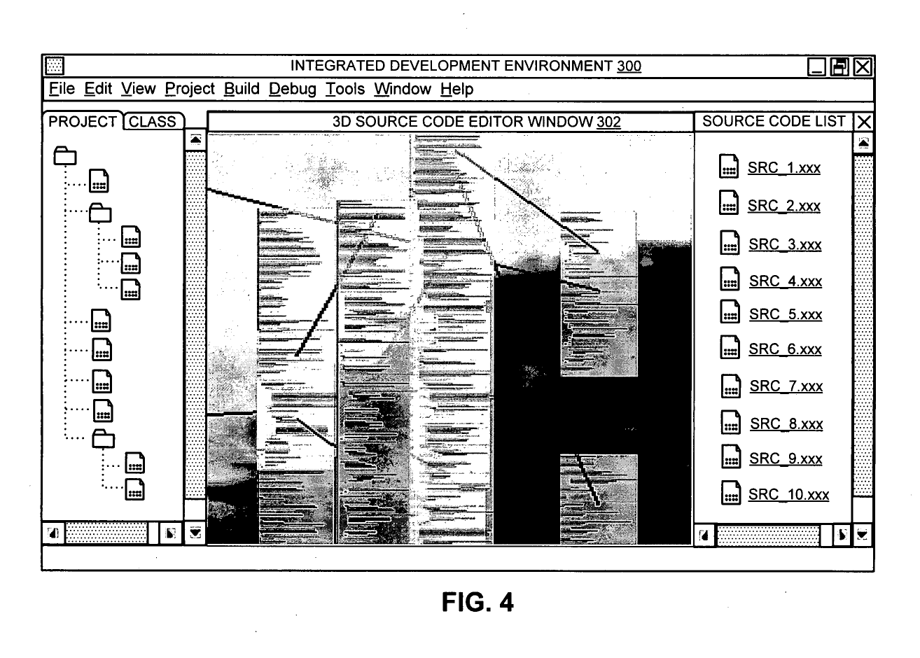

FIG. 4 illustrates an exemplary result after applying a zoom-in effect to box 306 in FIG. 3 in accordance with an embodiment of the present invention. Note that the visual resolution of the contents within the boxes is improved from FIG. 3, but is still not high enough to be readable. Hence, in order to edit the source code file, the user needs to zoom in further. In one embodiment of the present invention, the box containing the source code file can transform into a fully interactive editor window for the associated source code file at a specific zoom-in level, which allows a user to edit the source code file inside the box.

On the other hand, a user can zoom out from a close-up view of the contents within the box to an arbitrarily scaled-down size of the box, which typically results in a loss of visual resolution of the contents of the box.

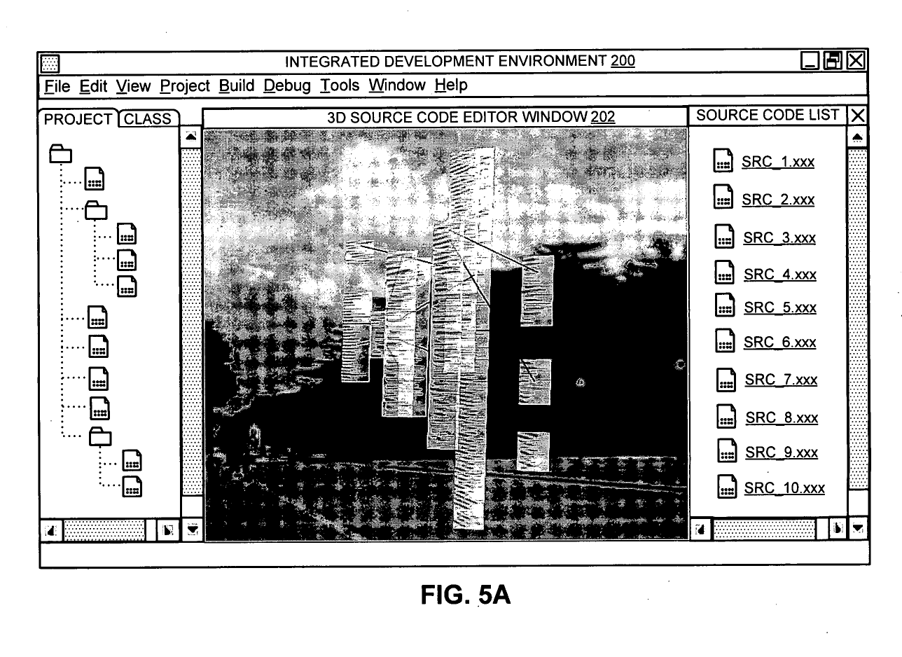

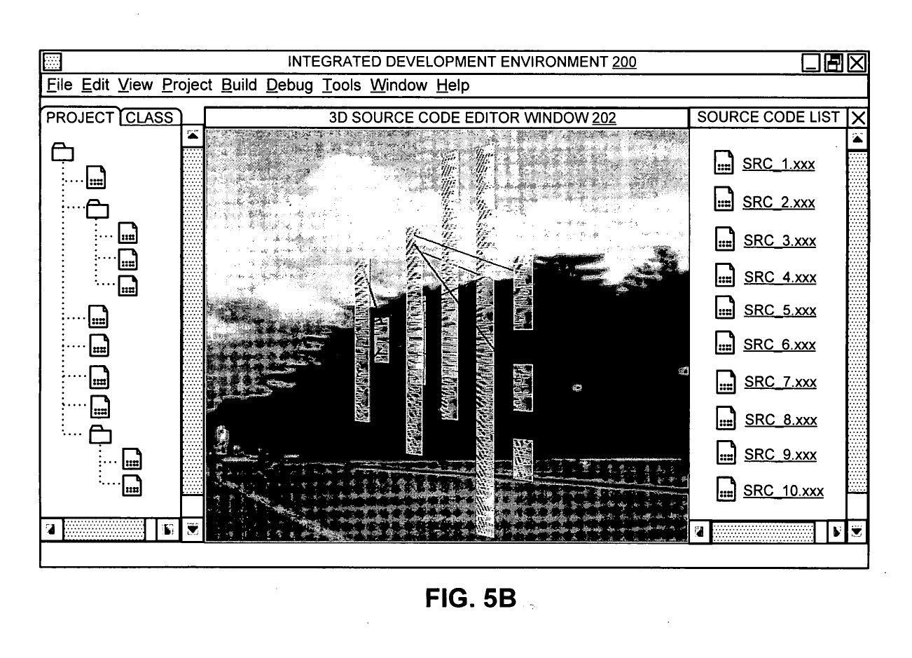

Additionally, the user can manipulate the scaled-down 3D version of the source code files by rotating and moving around the version using the 3D rendering effects. This allows the user to view the contents of the boxes from different angles. In particular, for a complex call-graph structure with many crossover links, rotating and moving around the scaled-down 3D versions of the source code files facilitates tracking and following calls through the links. FIGS. 5A and 5B illustrate rotated views of the scaled-down 3D version of the source code files in FIG. 3 at different viewing angles in accordance with an embodiment of the present invention. Note that in FIG. 3 some of the links are difficult to follow because of the overlapping boxes. However, as the viewing angle changes to FIG. 5A and further to FIG. 5B, every link within the call-graph can be clearly viewed.

Note that the above-described 3D GUI enables a user to use spatial memory to navigate the 3D code space. Generally, the human brain is very adept at remembering where objects are located in 3D space and how the objects are related to each other. Hence, as the user zooms in and out and navigates around the 3D object windows within the IDE, the user can quickly develop a virtual map of how the files/objects are spatially related, and can subsequently utilize this virtual map to locate files/objects that may be behind other objects in the 3D space. This provides much more powerful information than the traditional tab ordering methods found in most existing IDEs, wherein files/objects are typically grouped alphabetically without other relationship information.

Applying 3D Rendering Effects to a Source Code Editor

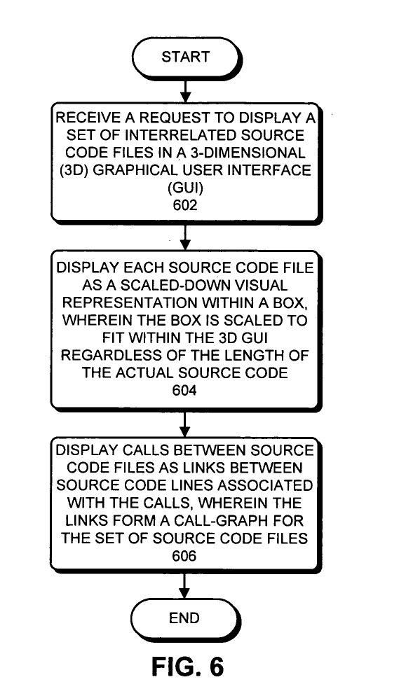

FIG. 6 presents a flowchart illustrating the process of applying 3D rendering effects to a source code editor in accordance with an embodiment of the present invention.

During operation, the system receives a request from a user to display a set of interrelated source code files in a 3D GUI (step 602). In one embodiment of the present invention, these source code files belong to a specific project or application which is being developed.

In response to the request, the system displays each source code file as a scaled-down version of the actual source code within a box in the 3D GUI (step 604). Each box is scaled to fit within a viewing window of the 3D GUI regardless of the length of the source code in the file.

Next, the system displays calls between the set of source code files as links between source code lines which are associated with the calls, wherein the links form a call-graph between the set of source code files (step 606).

The above-described 3D visualization system can be further extended to debugging and profiling tools within an IDE, which allows users to visually track execution paths within the source codes and to visually associate profiling data associated with the relevant source code. Such applications can be either integrated with the above-described 3D source code editor window or as standalone modules within the IDE.

In one embodiment of the present invention, during the debugging phase of code development, call stacks, which are associated with function/method calls within the source code files, can be displayed in the 3D GUI as scaled-down versions of the actual call-stack windows. These call-stack windows can be displayed next to the associated source code files, so that links can be drawn to connect the source code lines to the associated entries in the call-stack windows. Note that when the debugging involves a large number of threads, wherein each thread has its own call stack, using the scaled-down call-stack windows enables the system to display all of these windows on the same screen for simultaneous viewing. Also note that all of the above-discussed 3D rendering effects, such as zooming and rotating, can be extended to the call-stack windows.

To further facilitate the debugging process, stack variables associated with the call stacks can be displayed in stack-variable windows in the same 3D GUI as the source code files and call stack windows are displayed in. In one embodiment of the present invention, 3D animation effects and color codes are used to highlight the entries of the stack variable windows to indicate both changes of the associated variable values and the rate of change of the variables.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using three-dimensional (3D) rendering effects within a 3D graphical user interface (GUI) to enable a user to efficiently visualize and navigate through complex source code structures, the method comprising:
receiving a request to display a set of source code files in a 3D GUI; and
in response to the request,
displaying each source code file in the set as a scaled-down version of the actual source code within a box in the 3D GUI, wherein the box is scaled to fit within a viewing window of the 3D GUI regardless of the length of the source code in the file, and
displaying calls between source code files as links between source code lines associated with the calls, wherein the links form a call-graph between the set of source code files,
wherein the scaled-down source code within the box preserves the structure of the actual source code file, including line lengths and indentations.

2. The method of claim 1, further comprising allowing a user to zoom in and zoom out on each scaled-down version of a source code file by using 3D rendering effects to increase and decrease the visual resolution of the contents within the associated box.

3. The method of claim 2, wherein a box containing a source code file transforms into a code editor window for the associated source code file at a specific zoom-in level, which allows a user to edit the source code file.

4. The method of claim 1, wherein the boxes associated with the scaled-down versions of the source code files can overlap in the 3D GUI to facilitate a compact visual representation, wherein portions of the boxes which overlap are displayed through translucency.

5. The method of claim 1, further comprising allowing a user to rotate and move around the boxes associated with the scaled-down version of the source code files using the 3D rendering effects to enable the user to view the contents within the boxes from different angles.

6. The method of claim 1, wherein if the user edits a source code file, the associated call-graph between the set of source code files is updated concurrently.

7. The method of claim 1, wherein the 3D GUI is part of an integrated development environment (IDE).

8. The method of claim 1, wherein the method is performed by debugging tools, wherein the method additionally involves displaying:
call stacks associated with the source code files; and
stack variables associated with the call stacks.

9. A computer-readable storage medium storing instructions that when executed by a computer cause the computer to perform a method for using three-dimensional (3D) rendering effects within a 3D graphical user interface (GUI) to enable a user to efficiently visualize and navigate through complex source code structures, the method comprising:
receiving a request to display a set of source code files in a 3D GUI; and in response to the request,
displaying each source code file in the set as a scaled-down version of the actual source code within a box in the 3D GUI, wherein the box is scaled to fit within a viewing window of the 3D GUI regardless of the length of the source code in the file, and
displaying calls between source code files as links between source code lines associated with the calls, wherein the links form a call-graph between the set of source code files,
wherein the scaled-down source code within the box preserves the structure of the actual source code file, including line lengths and indentations.

10. The computer-readable storage medium of claim 9, wherein the method further comprises allowing a user to zoom in and zoom out on each scaled-down version of a source code file by using 3D rendering effects to increase and decrease the visual resolution of the contents within the associated box.

11. The computer-readable storage medium of claim 10, wherein a box containing a source code file transforms into a code editor window for the associated source code file at a specific zoom-in level, which allows a user to edit the source code file.

12. The computer-readable storage medium of claim 9, wherein the boxes associated with the scaled-down versions of the source code files can overlap in the 3D GUI to facilitate a compact visual representation, wherein portions of the boxes which overlap are displayed through translucency.

13. The computer-readable storage medium of claim 9, wherein the method further comprises allowing a user to rotate and move around the boxes associated with the scaled-down version of the source code files using the 3D rendering effects to enable the user to view the contents within the boxes from different angles.

14. The computer-readable storage medium of claim 9, wherein if the user edits a source code file, the associated call-graph between the set of source code files is updated concurrently.

15. The computer-readable storage medium of claim 9, wherein the 3D GUI is part of an integrated development environment (IDE).

16. The computer-readable storage medium of claim 9, wherein the method is performed by debugging tools, wherein the method additionally involves displaying:
call stacks associated with the source code files; and
stack variables associated with the call stacks.

17. An apparatus that uses three-dimensional (3D) rendering effects within a 3D graphical user interface (GUI) to enable a user to efficiently visualize and navigate through complex source code structures, comprising:
a receiving mechanism configured to receive a request to display a set of source code files in a 3D GUI;
a display mechanism configured to display each source code file in the set as a scaled-down version of the actual source code within a box in the 3D GUI, wherein the box is scaled to fit within a viewing window of the 3D GUI regardless of the length of the source code in the file; and
wherein the display mechanism is additionally configured to display calls between source code files as links between source code lines associated with the calls, wherein the links form a call-graph between the set of source code files,
wherein the scaled-down source code within the box preserves the structure of the actual source code file, including line lengths and indentations.

18. The apparatus of claim 17, wherein the display mechanism is configured to allow a user to zoom in and zoom out on each scaled-down version of a source code file by using 3D rendering effects to increase and decrease the visual resolution of the contents within the associated box.

19. The apparatus of claim 18, wherein a box containing a source code file transforms into a code editor window for the associated source code file at a specific zoom-in level, which allows a user to edit the source code file.

20. The apparatus of claim 17, wherein the boxes associated with the scaled-down versions of the source code files can overlap in the 3D GUI to facilitate a compact visual representation, wherein portions of the boxes which overlap are displayed through translucency.

21. The apparatus of claim 17, wherein the display mechanism is configured to allow a user to rotate and move around the boxes associated with the scaled-down version of the source code files using the 3D rendering effects to enable the user to view the contents within the boxes from different angles.

22. The apparatus of claim 17, wherein if the user edits a source code file, the associated call-graph between the set of source code files is updated concurrently.

23. The apparatus of claim 17, wherein the 3D GUI is part of an integrated development environment (IDE).

24. The apparatus of claim 17, wherein the display mechanism is configured to display:
call stacks associated with the source code files; and
stack variables associated with the call stacks.
